(19) United States
(12) Patent Application Publication
(10) Pub. No.: US 2020/0350099 A1
(43) Pub. Date: Nov. 5, 2020

(54) ELECTROCONDUCTIVE PATH AND WIRE HARNESS

(71) Applicant: SUMITOMO WIRING SYSTEMS, LTD., Yokkaichi-shi, Mie-ken (JP)

(72) Inventors: Hirokazu NAKAI, Yokkaichi-shi (JP); Manai YOKOTA, Yokkaichi-shi (JP)

(21) Appl. No.: 16/963,035

(22) PCT Filed: Jan. 17, 2019
(86) PCT No.: PCT/JP2019/001317

§ 371 Date: Jul. 17, 2020

(30) Foreign Application Priority Data
Jan. 22, 2018 (JP) 2018-008292

(51) Int. Cl. H01B 9/00; H01R 4/02; B60R 16/02

(52) U.S. Cl. CPC H01B 9/006; H01R 4/021; H01B 7/0009; H01R 2201/26; B60R 16/0215

(57) ABSTRACT

This wire harness comprises an electroconductive path 10A formed into an elongated shape, and a pair of terminal parts 70, respectively connected at both end sections of the electroconductive path 10A. The electroconductive path 10A has a plurality of split electric wires 30, 40, routed in parallel between the pair of terminal parts 70. The split electric wire 30 has a core wire 31 and an insulation cover 32 covering the core wire 31. The split electric wire 40 has a core wire 41 and an insulation cover 42 covering the core wire 41.

### BACKGROUND

### Field of the Disclosure

The present disclosure relates to an electroconductive path and a wire harness.

### Related Art

A typical wire harness used in a vehicle such as a hybrid vehicle or an electric car includes a wire that electrically connects electric devices such as a high-voltage battery and an inverter (for example, refer to Japanese Laid-Open Patent Publication No. 2016-58137).

As described above, electric devices used in a vehicle such as a hybrid vehicle or an electric car includes a high-voltage battery and an inverter. For example, a high current of a few hundred amperes may flow to the wire. When a high current flows to a wire, the thickness of the wire needs to be increased to prevent heat generation. However, increases in the thickness of the wire harden the wire and hinder bending of the wire.

To solve the above problem, it is an objective of the present invention to provide an electroconductive path and a wire harness that have improved flexibility while being used at a high current.

### SUMMARY

To solve the above problem, an electroconductive path is routed on a vehicle and has opposite ends connected to two terminal units. The electroconductive path includes a plurality of split wires routed in parallel between the two terminal units. Each split wire of the plurality of split wires includes a first core wire and a first insulation covering that covers the first core wire.

To solve the above problem, a wire harness includes the electroconductive path described above and the two terminal units connected to the opposite ends of the electroconductive path.

According to the present invention, the electroconductive path and the wire harness have improved flexibility while being used at high current.

### BRIEF DESCRIPTION OF THE DRAWINGS

FIG. 1 is a schematic diagram showing an embodiment of a wire harness.

FIG. 2 is a schematic cross-sectional view showing an embodiment of an electroconductive path.

FIG. 3 is a schematic plan view showing the embodiment of the electroconductive path.

FIG. 4 is a schematic plan view showing a modified example of an electroconductive path.

FIG. 5 is a schematic plan view showing a modified example of an electroconductive path.

FIG. 6 is a schematic plan view showing a modified example of an electroconductive path.

### DETAILED DESCRIPTION

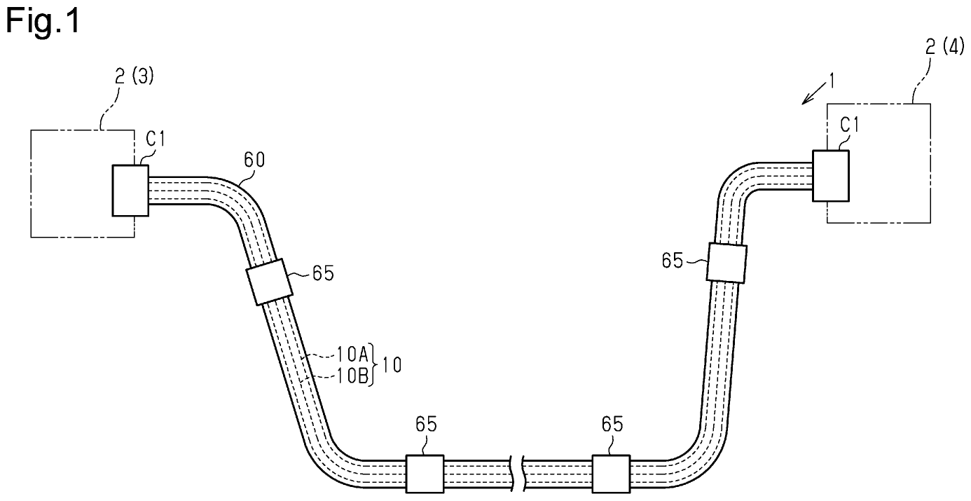

An embodiment of the present invention will now be described below with reference to FIGS. 1 to 3. In the drawings, components may be partially exaggerated or simplified to facilitate understanding. In addition, the components may not be drawn to scale.

FIG. 1 shows a wire harness 1 that electrically connects two or more electric devices 2 (devices). The wire harness 1 of the present embodiment electrically connects an inverter 3 and a high-voltage battery 4. The inverter is installed on a front portion of a vehicle such as a hybrid vehicle or an electric car. The high-voltage battery 4 is installed on the vehicle rearward from the inverter 3. The wire harness 1 is routed to extend, for example, under the floor of the vehicle. The inverter 3 is connected to a wheel-driving motor (not shown) that is used as a power source for the vehicle traveling. The inverter 3 generates an alternating current power from a direct current power of the high-voltage battery 4 and supplies the alternating current power to the motor. The high-voltage battery 4 is configured to supply a voltage of, for example, a few hundred volts.

The wire harness 1 includes a plurality of (in FIG. 1, two) electroconductive paths 10, two connectors C1 coupled to opposite ends of each electroconductive path 10, a protective tube 60 surrounding the electroconductive paths 10 in a bundle, and a plurality of (in FIG. 1, four) clamps 65. Each electroconductive path 10 has an elongated shape and extends in the front-rear direction of the vehicle. The electroconductive path 10 is, for example, a high-voltage wire that may be used at high voltage and high current. The electroconductive path 10 is, for example, a non-shielded wire, which does not have a shielded structure. The electroconductive paths 10 of the present example include two high-voltage wires, namely, a positive-side electroconductive path 10A connected to a positive terminal of the high-voltage battery 4 and a negative-side electroconductive path 10B connected to a negative terminal of the high-voltage battery 4. One end of each of the electroconductive paths 10A and 10B is connected to the inverter 3 by one of the connectors C1. The other end of each of the electroconductive paths 10A and 10B is connected to the high-voltage battery 4 by another one of the connectors C1. The protective tube 60 protects the electroconductive paths 10 from, for example, flying debris and moisture. The protective tube 60 accommodating the electroconductive paths 10 is fastened to, for example, a body of the vehicle by the clamps 65.

The structure of the electroconductive paths 10A and 10B will now be described. Here, the structure of the positive-side electroconductive path 10A will be described.

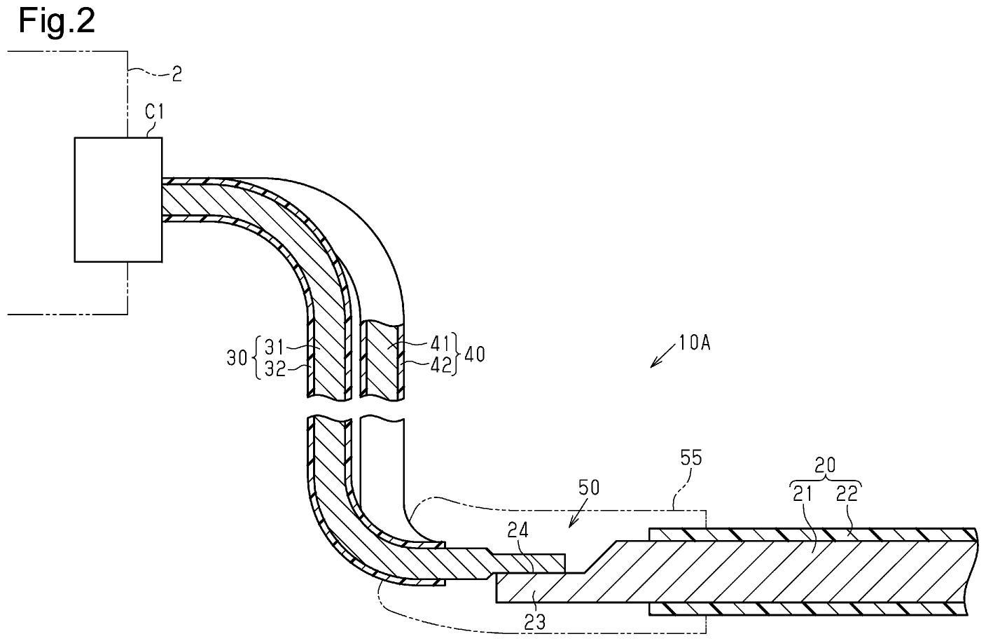

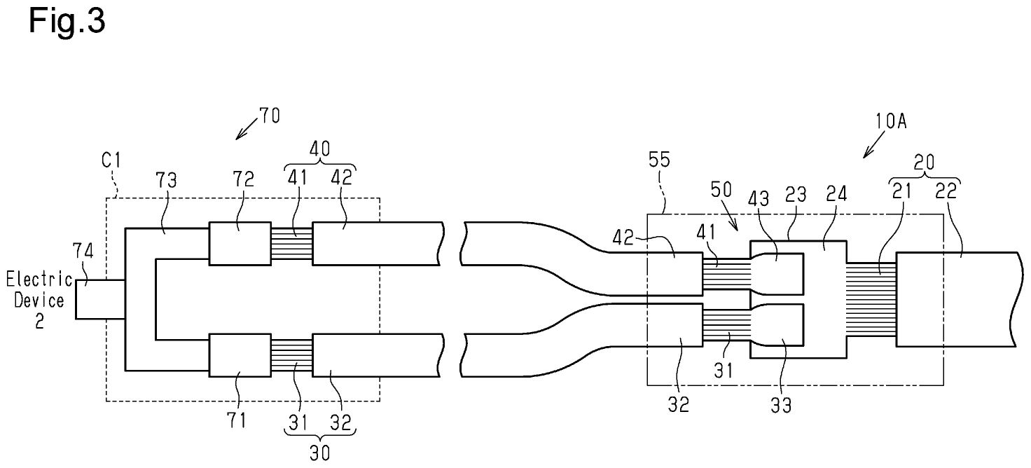

As shown in FIGS. 2 and 3, the positive-side electroconductive path 10A includes a single trunk wire 20, a plurality of (in this example, two) split wires 30 and 40 having a smaller diameter than the trunk wire 20, and a joint portion 50 that joins the two split wires 30 and 40 to the trunk wire 20.

The electroconductive path 10A is formed by electrically connecting the trunk wire 20 and the split wires 30 and 40, which differ in type from the trunk wire 20, in an extension direction of the electroconductive path 10A. More specifically, the electroconductive path 10A is formed by electrically connecting the trunk wire 20 to the split wires 30 and 40, which are formed separately from the trunk wire 20, in the extension direction. It is desirable that opposite ends of the electroconductive path 10A have a good bendability to facilitate the connecting task to the electric devices 2 such as the inverter 3 and the high-voltage battery 4. However, it is preferred that the largest portion of the electroconductive path 10A excluding the opposite ends maintains a predetermined shape to prevent, for example, sagging. In this regard, in the present embodiment, the split wires 30 and 40, which are relatively flexible (have a low rigidity and are easy to bend), are routed in the opposite ends of the electroconductive path 10A. The trunk wire 20, which is relatively hard (has a high rigidity and resists to bending), is routed in a portion of the electroconductive path 10A excluding the opposite ends. More specifically, in the present embodiment, an intermediate portion of the electroconductive path 10A in the extension direction includes the trunk wire 20. The split wires 30 and 40 are connected to each of the opposite ends of the trunk wire 20 (FIGS. 2 and 3 show the split wires 30 and 40 at only one end).

The one trunk wire 20 and the two split wires 30 and 40 are electrically connected to each other by the joint portion 50 and have the same polarity. More specifically, in a region of the electroconductive path 10A where the split wires 30 and 40 are routed, the single trunk wire 20 is split into a plurality of (in this example, two) split wires 30 and 40 having the same polarity as the trunk wire 20. In the joint portion 50, the split wires 30 and 40 are electrically connected to each other, and the split wires 30 and 40 are joined together (collected). In addition, as shown in FIG. 3, in the connector C1, the split wires 30 and 40 are electrically connected to each other, and the split wires 30 and 40 are joined together (collected). That is, the split wires 30 and 40 are electrically connected to each other in the connector C1 at one end (hereafter may be referred to as “proximal end”) and are connected to each other in the joint portion 50 at the other end (hereafter may be referred to as “distal end”). In other words, the split wires 30 and 40 are routed parallel to each other between the joint portion 50 and the connector C1. For example, the split wires 30 and 40 are electrically connected in parallel to the two connectors C1. As shown in FIG. 2, the split wires 30 and 40 are routed to extend in the same direction. The split wires 30 and 40 are, for example, processed to be bent in the same direction. However, the split wire 30 and the split wire 40 are not formed integrally with each other. The split wire 30 is spaced apart from the split wire 40.

The trunk wire 20 is, for example, rigid enough to retain a shape conforming to the layout of the electroconductive path 10. For example, when mounted on the vehicle, the trunk wire 20 has rigidity such that a straight or bent state of the trunk wire 20 is not changed by vibration of the vehicle. The trunk wire 20 is routed in a portion of the layout of the electroconductive path 10A where routing is easy and the shape needs to be retained. The trunk wire 20 is routed to extend, for example, under the floor of the vehicle.

The trunk wire 20 includes a core wire 21 and an insulation covering 22 that covers the outer circumference of the core wire 21. The core wire 21 may be, for example, a twisted wire formed by twisting a plurality of metal elemental wires, a single core wire formed of a single rod-shaped (for example, cylindrical) metal rod having a solid inner structure, or a tubular conductor (pipe conductor) having a hollow inner structure. The core wire 21 of the present example is formed of a twisted wire. The material of the core wire 21 may be, for example, a metal having a good conductivity such as copper, a copper alloy, aluminum, or an aluminum alloy. The insulation covering 22, for example, covers the entire outer circumference of the core wire 21 in close contact with the core wire 21. The insulation covering 22 is formed from, for example, an insulation material such as a synthetic resin. The insulation covering 22 may be formed, for example, by performing extrusion (extrusion covering) on the core wire 21.

The split wires 30 and 40 are set to have a smaller diameter than the trunk wire 20 and have a better flexibility than the trunk wire 20. The split wires 30 and 40 are bent more easily than the trunk wire 20. Furthermore, bending the plurality of (in this example, two) split wires 30 and 40 together is easier than bending the single trunk wire 20. The split wires 30 and 40 are routed in a portion of the layout of the electroconductive path 10A corresponding to the periphery of the inverter 3 or the high-voltage battery 4 (e.g., opposite ends of the electroconductive path 10A) where the space is narrow and hampers the routing. The split wires 30 and 40 of the present example are routed in an oscillation area of the vehicle that is susceptible to vibration caused by the engine or the like and generates oscillation of the electroconductive path 10A. For example, the split wires 30 and 40 are routed in an area between the connector C1 and the clamp 65 located closest to the connector C1 (refer to FIG. 1).

The split wire 30 includes a core wire 31 and an insulation covering 32 that covers the outer circumference of the core wire 31. The split wire 40 includes a core wire 41 and an insulation covering 42 that covers the outer circumference of the core wire 41. The split wire 30 and the split wire 40 are formed separately from each other. For example, the insulation covering 32 of the split wire 30 is formed separately from the insulation covering 42 of the split wire 40.

For example, a twisted wire, a single core wire, or a tubular conductor may be used as each of the core wires 31 and 41. The core wires 31 and 41 of the present example are formed of twisted wires. The material of the core wires 31 and 41 may be, for example, a metal having a good conductivity such as copper, a copper alloy, aluminum, or an aluminum alloy. The type of metal used in the material of the core wires 31 and 41 may be the same as or may differ from that used in the material of the core wire 21 of the trunk wire 20. When the core wires 31 and 41 of the split wires 30 and 40 and the core wire 21 of the trunk wire 20 are formed from different types of metal, it is preferred that, for example, the core wires 31 and 41 are formed of copper or a copper alloy and that the core wire 21 is formed of aluminum or an aluminum alloy. Such a configuration allows for reduction in the diameters of the split wires 30 and 40 and reduction in the weight of the trunk wire 20.

The cross-sectional area of each of the core wires 31 and 41 (more specifically, area of a cross section orthogonal to the extension direction of the split wires 30 and 40) is set to be less than the cross-sectional area of the core wire 21 (more specifically, area of a cross section orthogonal to the extension direction of the trunk wire 20). For example, the cross-sectional area of each of the core wires 31 and 41 is (1/the total number of split wires 30 and 40)*(the cross-sectional area of the core wire 21). That is, in the present example, the cross-sectional area of each of the core wires 31 and 41 is set to be approximately (½)*(the cross-sectional area of the core wire 21). The area obtained by adding the cross-sectional areas of all of the plurality of (in this example, two) core wires 31 and 41 is set to be greater than or equal to the cross-sectional area of the core wire 21. The area obtained by adding the cross-sectional area of the core wire 21 and the cross-sectional areas of all of the core wires 31 and 41 are set, for example, in accordance with an amount of current flowing to the electroconductive path 10A (e.g., rated current). For example, when a current of 300 to 400 amperes flows to the electroconductive path 10A, the cross-sectional area of the core wire 21 may be set to approximately 60 to 100 mm², and the cross-sectional area of each of the core wires 31 and 41 may be set to approximately 30 to 50 mm².

The cross-sectional areas of the core wires 31 and 41 of the split wires 30 and 40 may be set to the same cross-sectional area. The cross-sectional areas of the core wires 31 and 41 of the split wires 30 and 40 may be set to different cross-sectional areas. In this case, it is preferred that, for example, one of the split wires 30 and 40 having a larger cross-sectional area is routed in the outer side of a bent portion of the electroconductive path 10A and that one of the split wires 30 and 40 having a smaller cross-sectional area is routed in the inner side of the bent portion of the electroconductive path 10A.

The insulation covering 32, for example, covers the entire outer circumference of the core wire 31 in close contact with the core wire 31. The insulation covering 42, for example, covers the entire outer circumference of the core wire 41 in close contact with the core wire 41. The insulation coverings 32 and 42 are formed from, for example, an insulation material such as a synthetic resin. The kind of material of the insulation coverings 32 and 42 may be the same as or may differ from that used in the insulation covering 22 of the trunk wire 20. For example, it is preferred that the material of the insulation coverings 32 and 42 is an insulation material that is softer than the insulation material forming the insulation covering 22. When the material of the insulation coverings 32 and 42 is selected as described above, the flexibility of the split wires 30 and 40 is improved as compared to that of the trunk wire 20. On the other hand, it is preferred that the material of the insulation covering 22 is an insulation material that is harder than the insulation material forming the insulation coverings 32 and 42. When the material of the insulation covering 22 is selected as described above, the shape retaining property of the trunk wire 20 is improved as compared to that of the split wires 30 and 40.

The radial thickness of the insulation coverings 32 and 42 is less than the radial thickness of the insulation covering 22. This improves the flexibility of the split wires 30 and 40 as compared to that of the trunk wire 20. The insulation covering 32 may be formed, for example, by performing extrusion on the core wire 31. The insulation covering 42 may be formed, for example, by performing extrusion on the core wire 41.

In the joint portion 50, the distal ends of the split wires 30 and 40 are electrically connected to each other and also electrically connected to one end of the trunk wire 20. In the joint portion 50, one end of the core wire 21 is electrically connected to the distal ends of the core wires 31 and 41. More specifically, the insulation covering 22 is removed from one end of the trunk wire 20 to expose the core wire 21 in a range of a predetermined length from the extremity of the trunk wire 20. Also, the insulation coverings 32 and 42 are removed from the distal ends of the split wires 30 and 40 to expose the core wires 31 and 41 in a range of a predetermined length from the extremity of each of the split wires 30 and 40. In the joint portion 50, the plurality of (in this example, two) core wires 31 and 41 exposed from the insulation coverings 32 and 42 is connected to the single core wire 21 exposed from the insulation covering 22.

In the joint portion 50 of the present example, the two core wires 31 and 41 are separately overlapped with and joined to the single core wire 21 in a radial direction (direction intersecting the axial direction of each of the core wires 31 and 41). More specifically, the end of the core wire 21 exposed from the insulation covering 22 is crushed into a plate shape to define a crushed portion 23. The crushed portion 23 is, for example, bent in the radial direction of the core wire 21 so that a step is formed between the crushed portion 23 and the portion other than the crushed portion 23. The crushed portion 23 of the present example is formed toward one side in the radial direction (thickness-wise direction) of the core wire 21. In the present example, the entirety of the crushed portion 23 is formed toward one side from the axis of the core wire 21. The crushed portion 23 includes a joint surface 24 joined to the split wires 30 and 40. The joint surface 24 is flat and parallel to the axis of the core wire 21. As shown in FIG. 3, the width-wise dimension (dimension in vertical direction in FIG. 3) of the crushed portion 23 is formed to be greater than the radial dimension of the remaining uncrushed portion of the core wire 21. For example, the crushed portion 23 is crushed and widened in the width-wise direction.

As shown in FIGS. 2 and 3, the end of the core wire 31 exposed from the insulation covering 32 includes a block portion 33. For example, elemental wires of the core wire 31 are welded to each other as a block, so that the block portion 33 is formed. The block portion 33 is, for example, low-profile-rectangular-box-shaped. The height-wise dimension (dimension in vertical direction in FIG. 2) of the block portion 33 is formed to be less than the radial dimension of the remaining portion of the core wire 31. The width-wise dimension (dimension in vertical direction in FIG. 3) of the block portion 33 is formed to be greater than the radial dimension of the remaining portion of the core wire 31. The block portion 33 of the present example is formed toward the radial center of the core wire 31. For example, the block portion 33 is formed so that the center of the block portion 33 in the thickness-wise direction substantially coincides with the axis of the core wire 31. Formation of the block portion 33 in the end of the core wire 31 forms steps on opposite sides of the block portion 33 in the height-wise direction. As shown in FIG. 3, the end of the core wire 41 exposed from the insulation covering 42 includes a block portion 43 in the same manner as the block portion 33.

The distal ends (block portions 33 and 43) of the core wires 31 and 41 are separately overlapped with and joined to the joint surface 24 of the core wire 21. As a result, the single core wire 21 is electrically connected to the plurality of core wires 31 and 41. For example, ultrasonic welding or laser beam welding may be used as the process for joining the core wire 21 to the core wires 31 and 41.

As shown in FIGS. 2 and 3, the joint portion 50 is, for example, covered by an insulation member 55. The insulation member 55 is formed, for example, to extend between the insulation covering 22 of the trunk wire 20 and the insulation coverings 32 and 42 of the split wires 30 and 40. One end of the insulation member 55 covers an outer circumferential surface of the extremity of the insulation covering 22. The other end of the insulation member 55 covers an outer circumferential surface of the extremity of each of the insulation coverings 32 and 42. The insulation member 55 ensures electrical insulation of the joint portion 50 and the core wires 21, 31, and 41 exposed from the insulation coverings 22, 32, and 42. The radial thickness of the insulation member 55 is, for example, less than the radial thickness of the insulation covering 22 and the radial thickness of the insulation coverings 32 and 42. The insulation member 55 may be formed of, for example, a shrinkable tube, a rubber tube, an insulation tape, a hard protector formed from synthetic resin, or a combination of these. The shrinkable tube may be, for example, a heat-shrink tube.

As shown in FIG. 3, the proximal ends of the split wires 30 and 40 are electrically connected to each other in the connector C1. In addition, the proximal ends of the split wires 30 and 40 are joined together in the connectors C1 and connected to the electric device 2 by the connector C1.

The proximal end of each of the split wires 30 and 40 is connected to a terminal unit 70 disposed in the connector C1. The terminal unit 70 of the present example includes a plurality of terminal parts 71 and 72, a connection member 73, and a terminal 74. The terminal parts 71 and 72, the connection member 73, and the terminal 74 are formed, for example, of metal having a good conductivity.

The proximal end of the split wire 30 is connected to the terminal part 71. The proximal end of the split wire 40 is connected to the terminal part 72. The insulation coverings 32 and 42 are removed from the proximal ends of the split wires 30 and 40 to expose the core wires 31 and 41 in a range of a predetermined length from the extremity of each of the split wires 30 and 40. The proximal ends of the core wires 31 and 41 exposed from the insulation coverings 32 and 42 are connected to the terminal parts 71 and 72, respectively. The terminal part 71 is, for example, crimped and connected to the core wire 31. The terminal part 72 is, for example, crimped and connected to the core wire 41. As a result, the terminal part 71 is electrically connected to the core wire 31. The terminal part 72 is electrically connected to the core wire 41.

The plurality of (in this example, two) terminal parts 71 and 72 is electrically connected to the single connection member 73. All of the terminal parts 71 and 72 are electrically connected to the common connection member 73. The terminal parts 71 and 72 are electrically connected to each other by the connection member 73. Thus, the split wires 30 and 40 are electrically connected to each other by the terminal parts 71 and 72 and the connection member 73.

The connection member 73 is electrically connected to the terminal 74. The terminal 74 is electrically connected to the electric device 2. Therefore, the split wires 30 and 40 are electrically connected to the electric device 2 by the terminal parts 71 and 72, the connection member 73, and the terminal 74. In other words, the split wires 30 and 40 are collected together in the connector C1 and electrically connected to the electric device 2.

The structure of the negative-side electroconductive path 10B is the same as the structure of the positive-side electroconductive path 10A described above and will not be described in detail.

As shown in FIG. 1, the protective tube 60 is an elongated tube as a whole. The protective tube 60 is disposed to surround the electroconductive paths 10A and 10B including the trunk wire 20 and the split wires 30 and 40 in a bundle. The protective tube 60 may be, for example, a metal or resin pipe, a flexible corrugated tube formed from resin or the like, a waterproof rubber cover, or a combination of these. For example, it is preferred that a protective tube having a good flexibility (e.g., corrugated tube or waterproof rubber cover) is used as the protective tube 60 surrounding the split wires 30 and 40.

The clamps 65 are disposed on any positions in the extension direction of the protective tube 60. The clamps 65 are disposed, for example, on portions of the protective tube 60 surrounding the split wires 30 and 40. The clamps 65 are disposed, for example, on portions of the protective tube 60 surrounding the trunk wire 20.

The present embodiment has the operation and advantages described below.

The single electroconductive path 10 is split into the split wires 30 and 40. The split wires 30 and 40 are connected in parallel to the two connectors C1. As compared to when the single electroconductive path 10 is formed of a single wire, the diameter of each of the split wires 30 and 40 is reduced. Thus, the flexibility and bendability of the split wires 30 and 40 are improved. In addition, the parallel routing of the split wires 30 and 40 allows current to readily flow to the electroconductive path 10 in an amount equivalent to when the single electroconductive path 10 is formed of a single wire. Thus, the flexibility of the electroconductive path 10 is improved while being used at high current.

In a comparative example, when a current of 300 to 400 amperes flows to the electroconductive path 10, the cross-sectional area of a conductor in the electroconductive path 10 needs to be set to approximately 60 to 100 mm². This significantly increases the thickness of the electroconductive path 10. When the thickness of the electroconductive path 10 is increased as described above, the flexibility of the electroconductive path 10 is significantly lowered, and bending of the electroconductive path 10 is difficult.

In this regard, in the present embodiment, the single electroconductive path 10 is formed of the two split wires 30 and 40 that are routed in parallel. With this configuration, even when a current of 300 to 400 amperes flows to the electroconductive path 10, the cross-sectional area of each of the core wires 31 and 41 of the split wires 30 and 40 may be set to approximately 30 to 50 mm². This reduces the diameters of the split wires 30 and 40 as compared to when the single electroconductive path 10 is formed of a single wire. Thus, the split wires 30 and 40 improve the flexibility of the electroconductive path 10 while maintaining the amount of current that is allowed to flow to the electroconductive path 10. As a result, the electroconductive path 10 (split wires 30 and 40) is readily bent. The electroconductive path 10 (split wires 30 and 40) may be bent two-dimensionally or three-dimensionally in accordance with a desired routing path (layout).

The split wires 30 and 40 are routed in an oscillation area of the vehicle that is susceptible to vibration caused by the engine or the like and generates oscillation of the electroconductive path 10. Thus, even when the electroconductive path 10 is oscillated in the oscillation area, the split wires 30 and 40 having a good flexibility absorb the oscillation and limit damage such as breakage of the electroconductive path 10. In addition, shocks caused by oscillation are released from the bending of the split wires 30 and 40. This reduces loads applied to the clamps 65 disposed in the oscillation area. Thus, damage to the clamps 65 is limited.

The terminal unit 70 (connector C1) is connected to one end (proximal end) of each of the split wires 30 and 40. More specifically, the split wires 30 and 40 having a good flexibility are disposed on an end of the electroconductive path 10. This improves the efficiency of the task for connecting the electroconductive path 10 to the electric device 2. In addition, when connecting the electroconductive path 10 to the electric device 2, the split wires 30 and 40 provide a dimensional tolerance between the electroconductive path 10 and the electric devices 2.

The electroconductive path 10 includes the single trunk wire 20 and the plurality of split wires 30 and 40 connected to the trunk wire 20. With this configuration, the cross-sectional area of the trunk wire 20 is readily set to be increased. As a result, the trunk wire 20 is likely to retain its shape. This eliminates the need for the protective tube 60 surrounding the trunk wire 20 to have a shape retaining property. The degree of freedom for selecting the protective tube 60 is increased.

The trunk wire 20 is connected to the split wires 30 and 40, which are separate and different from the trunk wire 20. This allows the trunk wire 20 to be manufactured separately from the split wire 30 and the split wire 40. The cross-sectional area of the trunk wire 20, the cross-sectional area of the split wire 30, and the cross-sectional area of the split wire 40 may be separately set.

The split wires 30 and 40 are joined together in the connector C1 and connected to the electric device 2. Thus, the electric device 2 is connected with the same number of terminals as when the single electroconductive path 10 is formed of a single wire.

The above-described embodiment may be modified as follows.

In the embodiment, the radial thickness of the insulation coverings 32 and 42 of the split wires 30 and 40 may be greater than or equal to the radial thickness of the insulation covering 22 of the trunk wire 20.

In the embodiment, the radial thickness of the insulation member 55 may be greater than or equal to the radial thickness of the insulation covering 22 of the trunk wire 20. Also, the radial thickness of the insulation member 55 may be greater than or equal to the radial thickness of the insulation coverings 32 and 42 of the split wires 30 and 40.

In the embodiment, the number of split wires 30 and 40 connected to each of the opposite ends of the trunk wire 20 is not particularly limited. Three or more split wires may be connected to each of the opposite ends of the trunk wire 20. The number of split wires connected to one end of the trunk wire 20 may be the same as or may be different from the number of split wires connected to the other end of the trunk wire 20.

In the embodiment, the split wires 30 and 40 are connected to each of the opposite ends of the trunk wire 20. However, there is no limitation to such a configuration. For example, the split wires 30 and 40 may be connected to only one end of the trunk wire 20. In this case, for example, the other end of the trunk wire 20 is connected to the terminal unit 70.

In the embodiment, the single electroconductive path 10 is formed of the single trunk wire 20 and the plurality of split wires 30 and 40 connected to the trunk wire 20. However, there is no limitation to such a configuration of the electroconductive paths 10.

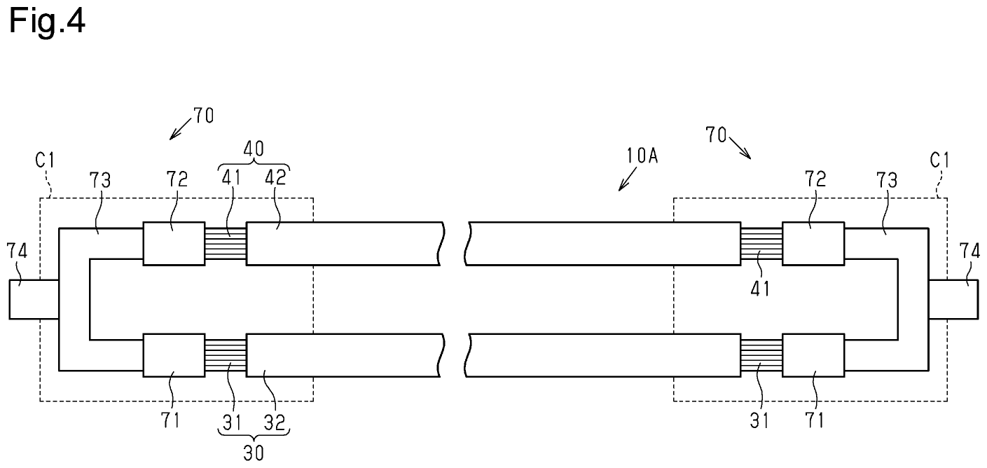

For example, as shown in FIG. 4, the single trunk wire 20 may be omitted, and the entire length of the single electroconductive path 10A may be formed of only the split wires 30 and 40. More specifically, only the split wires 30 and 40 may be routed between the two connectors C1. In this case, one end of each of the split wires 30 and 40 is connected to the terminal unit 70 disposed in one of the connectors C1. The other end of each of the split wires 30 and 40 is connected to the terminal unit 70 disposed in the other one of the connectors C1.

In the embodiment, the crushed portion 23 is formed toward one side in the radial direction of the core wire 21. Instead, the crushed portion 23 may be formed toward the radial center of the core wire 21. For example, the crushed portion 23 may be formed so that the center of the crushed portion 23 in the thickness-wise direction substantially coincides with the axis of the core wire 21. In this case, steps are formed on opposite sides of the crushed portion 23 in the thickness-wise direction.

In the embodiment, the block portions 33 and 43 are formed toward the radial center of the core wires 31 and 41. Instead, the block portions 33 and 43 may be formed toward one side in the radial direction of the core wires 31 and 41.

In the embodiment, the core wire 21 of the trunk wire 20 is overlapped with and joined to the core wires 31 and 41 of the split wires 30 and 40 in a direction intersecting the extension direction of the trunk wire 20 and the split wires 30 and 40. However, there is no limitation to such a configuration. The configuration of joining the core wire 21 to the core wires 31 and 41 may be changed in any manner. For example, an axial end surface of the core wire 21 may abut and join an axial end surface of each of the core wires 31 and 41.

In the embodiment, the core wire 21 of the trunk wire 20 includes the crushed portion 23, and the core wires 31 and 41 of the split wires 30 and 40 include the block portions 33 and 43. However, there is no limitation to such a configuration. For example, without including the crushed portion 23 and the block portions 33 and 43, the core wire 21 may be electrically connected to the core wires 31 and 41.

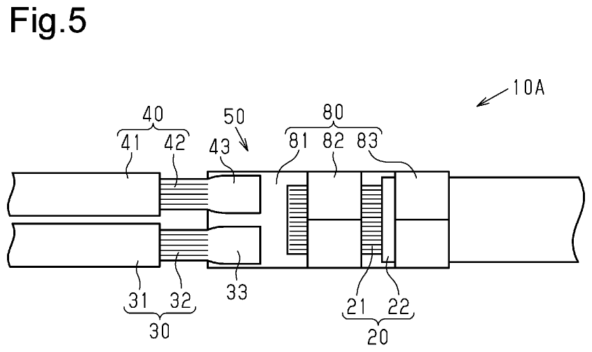

For example, as shown in FIG. 5, a connection terminal 80 may be used to electrically connect the core wire 21 and the core wires 31 and 41. The connection terminal 80 includes, for example, a connection portion 81, a core wire fastener 82 that fastens the connection terminal 80 to the core wire 21 of the trunk wire 20, and a covering fastener 83 that fastens the connection terminal 80 to the insulation covering 22 of the trunk wire 20. The connection terminal 80 is formed, for example, by pressing a metal plate having a good conductivity. For example, the connection portion 81, the core wire fastener 82, and the covering fastener 83 are formed integrally with each other.

The connection portion 81 has a flat shape. The distal ends of the core wires 31 and 41 are separately overlapped with and joined to the flat connection portion 81. For example, ultrasonic welding or laser beam welding may be used as the process for joining the connection portion 81 to the core wires 31 and 41. Alternatively, the connection portion 81 may be crimped and connected to the core wires 31 and 41. The core wire fastener 82 is crimped and connected to the core wire 21 of the trunk wire 20. The core wire fastener 82 includes, for example, two crimp pieces that are folded inward so that the core wire fastener 82 is crimped onto the core wire 21. The covering fastener 83 is crimped and connected to the insulation covering 22 of the trunk wire 20. The covering fastener 83 includes two crimp pieces that are folded inward so that the covering fastener 83 is crimped onto the insulation covering 22. The connection terminal 80 having such a configuration may be used to electrically connect the core wire 21 to the core wires 31 and 41.

In the embodiment, the terminal unit 70 includes the terminal parts 71 and 72 connected to the proximal ends of the core wires 31 and 41, the connection member 73, and the terminal 74. However, there is no limitation to such a configuration.

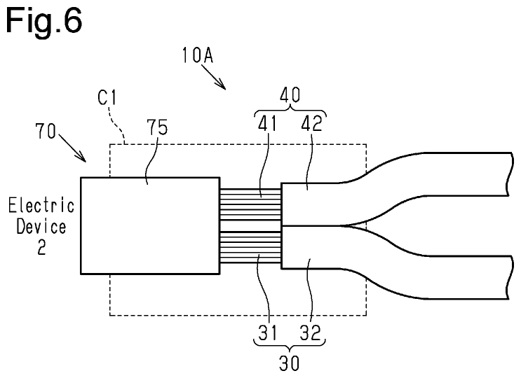

For example, as shown in FIG. 6, the terminal unit 70 may be formed of a single terminal 75. The terminal 75 is formed, for example, from metal having a good conductivity. For example, when the proximal end of the core wire 31 exposed from the insulation covering 32 and the proximal end of the core wire 41 exposed from the insulation covering 42 are bundled, the terminal 75 is crimped onto the bundle of the proximal ends of the core wires 31 and 41. As a result, the core wires 31 and 41 are electrically connected to the terminal 75, and the core wires 31 and 41 are electrically connected to each other by the terminal 75. The terminal 75 is electrically connected to the electric device 2.

In the embodiment, the shapes of cross sections of the core wires 21, 31, and 41 are not particularly limited. For example, cross-sectional shapes of the core wires 21, 31, and 41 may be circular, semicircular, or polygonal.

In the embodiment, twisted wires are embodied in the core wires 31 and 41 of the split wires 30 and 40. However, there is no limitation to such a configuration. For example, a braided wire formed by braiding multiple metal elemental wires may be used as the core wires 31 and 41.

In the embodiment, the split wires 30 and 40 are disposed in the oscillation area. Instead, the split wires 30 and 40 may be disposed in a non-oscillation area that does not generate oscillation of the electroconductive paths 10.

In the embodiment, the two electroconductive paths 10 are inserted through the protective tube 60. However, there is no particular limitation to such a configuration. The number of electroconductive paths 10 may be changed in accordance with specifications of the vehicle. For example, the number of electroconductive paths 10 inserted through the protective tube 60 may be one or three or more.

In the embodiment, the electric devices 2 connected by the electroconductive paths 10 are the inverter 3 and the high-voltage battery 4. However, there is no limitation to such a configuration. For example, the embodiment may be applied to an electroconductive path that connects the inverter 3 to a motor for driving wheels. More specifically, the embodiment is applicable to any electroconductive path that electrically connects electric devices mounted on a vehicle.

Although not particularly described in the embodiment, an electromagnetic shield member may be disposed inside the protective tube 60. The electromagnetic shield member is disposed, for example, to surround the electroconductive paths 10 as a bundle. The electromagnetic shield member is disposed, for example, between an inner surface of the protective tube 60 and outer surfaces of the electroconductive paths 10. The electromagnetic shield member may be, for example, a flexible braided wire or a metal foil.

The embodiment and modified examples may be combined in any suitable manner.

It will be clear to those skilled in the art that the present invention may be embodied in different specific forms without departing from the technical concept of the invention. For example, some of the components described in the embodiment (or one or more aspects thereof) may be omitted or may be combined with each other. The scope of the present invention should be determined with reference to the appended claims, along with the full scope of equivalents to which such claims are entitled.

### DESCRIPTION OF THE REFERENCE NUMERALS

1) wire harness; 2) electric device; 10, 10A, 10B) electroconductive path; 20) trunk wire; 21) core wire (second core wire); 22) insulation covering (second insulation covering); 30, 40) split wire; 31, 41) core wire (first core wire); 32, 42) insulation covering (first insulation covering); 50) joint portion; 60) protective tube; 65) clamp; 70) terminal unit

1. An electroconductive path routed on a vehicle and having opposite ends configured to be connected to two terminal units, the electroconductive path, comprising:
a plurality of split wires routed in parallel; and
a single trunk wire configured to be connected to the plurality of split wires, wherein
the plurality of split wires and the single trunk wire are disposed between the two terminal units, and
each split wire of the plurality of split wires includes a first core wire and a first insulation covering that covers the first core wire.

2. The electroconductive path according to claim 1, characterized in that each of the split wires of the plurality of split wires has one end configured to be connected to one of the terminal units.

3. The electroconductive path according to claim 1, characterized in that
the trunk wire includes a second core wire and a second insulation covering that covers the second core wire, and
an end of each of the first core wires is electrically connected to an end of the second core wire.

4. The electroconductive path according to claim 3, wherein a radial thickness of the first insulation covering is less than a radial thickness of the second insulation covering.

5. The electroconductive path according to claim 3, wherein the first core wire and the second core wire are formed of different metals.

6. The electroconductive path according to claim 3, wherein an area obtained by adding cross-sectional areas of all of the first core wires is set to be greater than or equal to a cross-sectional area of the second core wire.

7. The electroconductive path according to claim 1, wherein when the electroconductive path is mounted on a vehicle, the plurality of split wires is disposed in an oscillation area.

8. A wire harness, comprising:
the electroconductive path according to claim 1; and
the two terminal units connected to the opposite ends of the electroconductive path.

9. (canceled)
